(19) United States
(12) Patent Application Publication
(10) Pub. No.: US 2011/0180504 A1
(43) Pub. Date: Jul. 28, 2011

(54) FURNITURE ASSEMBLY

(75) Inventors: John M. Riley, Millbrae, CA (US); Nikolaos Xanthopoulos, San Francisco, CA (US); William J. McHenry, San Francisco, CA (US)

(73) Assignee: elevations inc., South San Francisco, CA (US)

(21) Appl. No.: 13/028,119

(22) Filed: Feb. 15, 2011

Related U.S. Application Data
(60) Provisional application No. 61/338,270, filed on Feb. 16, 2010.

(51) Int. Cl. A47B 96/06; F16M 13/00; F16B 45/00; B23P 11/00

(52) U.S. Cl. 211/183; 248/298.1; 29/428

(57) ABSTRACT

Discussed herein is an improved furniture assembly, where stretchers are secured between beams of a shelving assembly using brackets. The stretchers include at least one hollow slot that is sufficiently wide to allow the slot to be slid over a protruding surface of the bracket. In embodiments, the brackets have a protruding surface that is substantially parallel to a base surface of the bracket. The bracket has one or more lock members allowing the bracket to be secured to punches on the beams. The brackets are capable of being secured to the punches without the need for special tools. After the brackets are locked within the beams, the stretcher is connected between the beams by simply aligning the slots of the stretcher over corresponding protruding surfaces of the brackets and sliding the stretcher over the brackets by sliding the slots over the protruding surfaces.

### PRIORITY CLAIM

This patent application claims priority to U.S. Provisional Patent Application No. 61/338,270 entitled “BRACKET ASSEMBLY SYSTEM,” filed Feb. 16, 2010, which is incorporated herein in its entirety.

### FIELD OF INVENTION

The present invention generally relates to furniture assemblies, specifically improved furniture assemblies as described in the following sections.

### BACKGROUND OF THE INVENTION

The use of shelves and a wide variety of other such furniture assemblies is known in the prior art. Specifically, shelves heretofore devised and utilized are known to consist basically of familiar, expected and obvious structural configurations, notwithstanding the myriad of designs encompassed by the crowded prior art which have been developed for the fulfillment of countless objectives and requirements. Examples of known prior art includes U.S. Pat. No. 2,833,420; U.S. Pat. No. 4,018,167; U.S. Pat. No. 4,374,498; U.S. Pat. No. 4,669,692; U.S. Pat. No. 3,565,381; U.S. Pat. No. Des. 295,950; and U.S. Pat. No. 6,505,800.

FIGS. 1A-1D describe common features of shelving assemblies in known prior art. For example, as illustrated in FIG. 1A, a representative embodiment of a shelving assembly 100 includes multiple upright beams 102A, 102B, 102C. These upright beams (or simply, “beams”) provide the basic building blocks for structural integrity of the shelving assembly. In constructing a shelving assembly, several beams are typically arranged together to provide structural support for placing horizontal surfaced shelves (e.g., 108). To provide the dimensionality required for placing shelves, the beams are interconnected using one or more stretcher bars (or stretchers) 104A, 104B to provide structural connectivity. In some instances, a stretcher may be used to connect between two beams allowing shelves to be supported and/or extended laterally from the two beams. In other instances, as illustrated in FIG. 1A, more than two beams may be used to ensure that the shelf 108 is supported on all four corners. The shelf 108 is typically placed over or attached to the stretchers 104A, 104B. The addition of two more stretchers may, in some instances, provide longitudinal support to the shelf along the four edges, preventing bowing of the shelf under heavy load. In some instances, a shelf by itself may be placed directly over multiple brackets without the need for any stretchers. In other instances, it may be envisioned that the stretchers are essentially affixed to or are an essential element of shelves.

Prior art provides a variety of mechanisms by which the stretcher 104A, 104B may be connected or locked to the beams 102A, 102B. In one example, as illustrated in FIGS. 1A and 1B, one or more support brackets 101 may be utilized to connect the stretchers 104A, 104B to the beams 102A and 102B. In some instances, the beams have “punches” at various height intervals, allowing a support bracket or any other bracket to be hooked on. The brackets may simply be hooked on, or may be connected to the punches by means of screws or other attachment mechanisms known to people of ordinary skill in the art. In the examples of FIGS. 1A and 1B, the support bracket 101 has at least two surfaces. A hook member 103A allows the support bracket 101 to be fixed (e.g., held in place by the shelf) within the beam. Further, the support bracket has a horizontal mountable surface 132A, 132B. When the support brackets 101 are fixed to the beams, the stretcher 104A may simply be allowed to rest on the support brackets, thus providing a shelving assembly. However, a problem with such an arrangement is that the structural integrity of the shelving assembly is limited by the integrity of the brackets. A high load on the shelf 108 would directly be transferred to the brackets (and not to the beams), causing the support brackets to impose a limitation on maximum load on the shelf 108. Specifically, the maximum load on the shelf is typically limited by the strength of the bracket, no matter what system is used. A high load on the shelf may cause the shelf or stretcher to bend, and this bending, in conjunction with the splaying of the uprights, may cause the stretcher or bracket to fail.

Additionally, the stretcher is not “locked” in place, and so further limits the sturdiness of the eventual shelving assembly. Further, when heavy loads are imposed on the beams, the beams have a tendency to “splay.” An example of splaying is when the beams bulge outward or inward (e.g., respective to their original upright orientation) in response to heavy load placed on the shelves (and hence the stretchers). The support bracket assembly does nothing to prevent the beams from splaying, further contributing to structural integrity issues. In embodiments, it may be useful for a user to attach accessories to the interconnecting stretcher 104A. Such accessories may extend outward from the stretcher, allowing additional utilitarian value. For example, in a retail display fixture, a user may simply use two beams, interconnected by one or more stretchers extending between the two beams. The user of the retail display fixture may then attach accessories (e.g., hanger rods) that laterally extend outwards from the beam and stretcher assembly. In the examples of FIG. 1B, the weight of the accessory or any weight added to such accessory may cause the stretcher to twist from its original resting position, further adding to the structural integrity issued discussed above.

The exemplary prior art illustration in FIG. 1C may operate to avoid some of the issues listed with reference to FIGS. 1A and 1B. Here, the bracket 102A includes a hook member 103A similar to the design in FIG. 1B, but instead of a support bracket with a flat resting surface (i.e., for example, 132A in FIG. 1B), the bracket illustrated in FIG. 1C includes a fitted bar member 182 that laterally projects from a base surface of the bracket. The fitted bar member has an opening on the top surface, allowing the stretcher 104A to be easily slid within. While this assembly may solve the problem of the stretcher sliding off the brackets (and in some cases, even of the twisting issue mentioned above), the predominant structural issue of splaying is still an issue with this design.

The exemplary prior art illustration in FIG. 1D may appear to avoid at least some of the issues detailed above. As illustrated in FIG. 1D, the stretcher 104B is interlocked within the two beams 102A and 102B by means of a screw bracket assembly. A bracket is simultaneously connected by screws to both a stretcher end and to the punch in the beam. While this assembly resolves some of the structural integrity issues (e.g., load maintenance, splaying, twisting, etc.) discussed above, it still has the following issues. First, the screw assembly requires tools and additional work for connecting the stretcher to the beams, making these assemblies more permanent in nature than the examples of FIGS. 1A and 1B (where the stretchers can easily be inserted and removed at will). Second, the screws reduce the aesthetic value of the shelving assembly—the screws are either visible on the outside of the beams, or a special covering may be needed over the beams to cover visible portions of the screw-heads.

In other prior art examples (not included in FIGS. 1A-1D), the stretchers may be bolted or welded permanently to the beams. While this would prevent the structural integrity issues associated with splaying, such assemblies offer limited flexibility and maneuverability. While the permanent fixture may be acceptable in an industrial warehouse where the stretcher assembly is permanently placed in position, such an assembly would simply not work in a scenario where the shelves and/or the stretchers need to be rearranged and refitted on a per-need basis (e.g., in a departmental clothing store where the shelves need to be constantly rearranged and refitted to effectively display merchandise).

Overall, the examples herein of some prior or related systems and their associated limitations are intended to be illustrative and not exclusive. Other limitations of existing or prior systems will become apparent to those of skill in the art upon reading the following Detailed Description.

### SUMMARY OF THE DESCRIPTION

Discussed herein is an embodiment of an improved furniture assembly. In the improved furniture assembly, stretchers or connectors are secured between beams of a furniture assembly using brackets constructed according to the embodiments discussed herein. The stretchers include at least one hollow slot that is sufficiently wide to allow the slot to be slid over a protruding surface of the bracket. In embodiments, the brackets have a protruding surface that is substantially parallel to a base surface of the bracket. The bracket has one or more lock members allowing the bracket to be secured to punches on the beams. The brackets are capable of being secured to the punches without the need for special tools. After the brackets are locked within the beams, the stretcher is connected between the beams by simply aligning the slots of the stretcher over corresponding protruding surfaces of the brackets and sliding the stretcher over the brackets by sliding the slots over the protruding surfaces.

In this manner, the stretcher is connected and interlocked between the multiple beams. The brackets, by virtue of its lock features, do not require a screw or other permanent fixture mechanisms (e.g., bolting, welding, etc.) to be locked within the beam. Similarly, the stretcher simply slides over the protruding surface feature of the bracket, eliminating the need for any permanent fixture mechanisms to secure the brackets or the beams. Despite the lack of permanent fixture mechanisms, the shelving assembly described herein possesses the structural integrity offered by certain prior art permanent fixture mechanisms. For example, the stretcher and bracket assembly lock the stretcher in position—because the slots of the stretcher are slid over the protruding surface, the stretcher is locked in that position and cannot be moved or slid from the position. Accordingly, the beams, by virtue of being held in place by the interconnected stretcher, are also held in position. Any load on the beams that may cause the beams to splay (i.e., bulge outwards or inwards) is transferred to the stretcher. The stretcher, by virtue of being locked in position by the bracket, dissipates the load laterally to the bottom of the beam structure. Such an arrangement also prevents the stretcher from “twisting” when a lateral load is attached in the form of, for example, an accessory affixed to the stretcher. Furthermore, it can be envisioned that the structural integrity of the shelving assembly increases with the increase in number of stretchers used to interconnect the beams.

In addition to providing the structural-integrity advantages discussed above, the improved furniture assembly described herein also provides aesthetic advantages over the permanent fixture assemblies. Because, in embodiments, the protruding extension slides completely within the slot extension, the features of the bracket are hidden to a casual observer. There are no unsightly screw extensions or coverings that may impair the aesthetic appeal of the shelf. Another advantage of the shelving assembly discussed herein is the easy usability and flexibility. A user can simply slide the stretcher out of the brackets without the need for any tools, and further easily refit the stretcher at another location of the beam by simply inserting the brackets and sliding the stretcher over the protruding extensions of the brackets. There is simply no need for any tools or special labor in the attachment and removal of the stretchers.

In these respects, the furniture assembly according to the present invention substantially departs from the conventional concepts and designs of the prior art. Other advantages and features will become apparent from the following description and claims. It should be understood that the description and specific examples are intended for purposes of illustration only and not intended to limit the scope of the present disclosure.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIGS. 1A-1D describe common features of shelving assemblies in known prior art;

FIG. 2A illustrates an embodiment of an improved furniture assembly according to the techniques discussed herein;

FIG. 2B illustrates an embodiment of an improved furniture assembly with an accessory attachment;

FIGS. 3A and 3B illustrate an exemplary embodiment of a bracket used in the improved furniture assembly;

FIGS. 4A-4E depict exemplary variations of the bracket; and

FIGS. 5A and 5B illustrate an exemplary process for sliding the stretcher within two brackets.

### DETAILED DESCRIPTION OF THE INVENTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

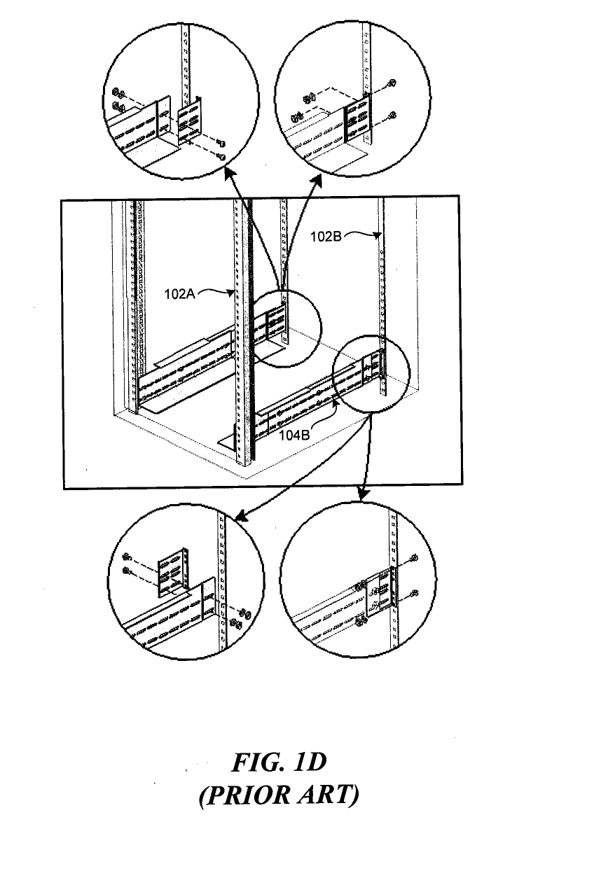

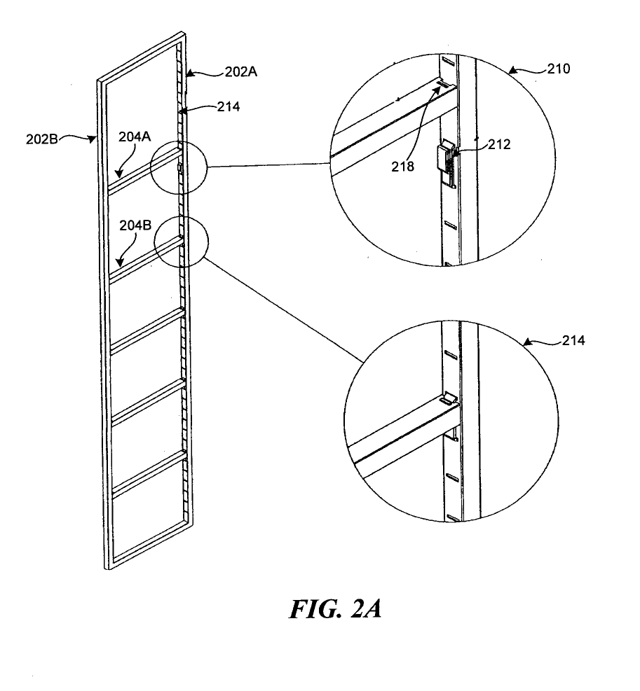

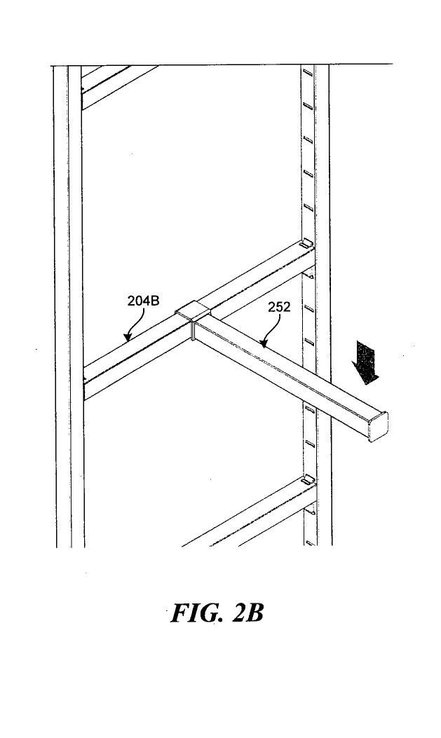

FIG. 2A illustrates an embodiment of an improved furniture assembly. For purposes of further illustration, the techniques introduced hereafter may be described in the context of “shelving assemblies.” Shelving assemblies represent exemplary embodiments of furniture assemblies. Furniture assemblies, as illustrated in the techniques described herein, may include any assembly of “beam” structures that results in a utilitarian structure. For example, the furniture assembly may include assemblies such as hang rods, portable stairs, steps, support structures, etc. The improved shelving assemblies that may be indicated herein are merely illustrative examples of improved furniture assemblies. The same basic approach described in the forthcoming sections, with respect to improved shelving assemblies, can also be applied to other furniture assembly contexts. In such contexts, “stretchers,” as described herein, are utilized for enabling interconnection, structural integrity, aesthetic appeal, etc., of the eventual furniture assembly.

Returning to FIG. 2A, beams 202A and 202B provide basic structural support for a shelving assembly. In typical instances, the beams 202A and 202B are in an upright position, allowing the stretchers 204A, 204B to be placed in a horizontal orientation. Of course, it is understood that the beams may be placed in any alternate orientation allowing the stretcher to be fitted in corresponding orientations in accordance with the techniques discussed herein. Additionally, the term “beam,” as used herein, is understood to be generic in nature and representative of any structural feature that allows stretchers to be interconnected. The beams 202A, 202B may be made of any material (e.g., wood, steel, plastic, etc.) as is understood in the art, and is not restricted to any particular size, dimension, or orientation. In embodiments, the beams include channels or punches 214 on one of its surfaces, allowing brackets to be locked in. The channels may be in the form of a perforation or a groove or any other shape or structure that simply allows a bracket to be hooked onto or otherwise attached to the beams. The punches 214 may be placed at different intervals, allowing flexible adjustability of the height of the eventual shelves.

The bracket 212 provides a mechanism for securing the stretcher 204A between multiple beams. As will be discussed in more detail below, the bracket includes at least one hook member or feature that allows the bracket to be locked to one of the beams. In embodiments, the bracket 212 includes a protruding surface. This protruding surface, in embodiments, is parallel to a base surface of the bracket and is adapted to allow the stretcher to easily slide over the bracket, as is explained below.

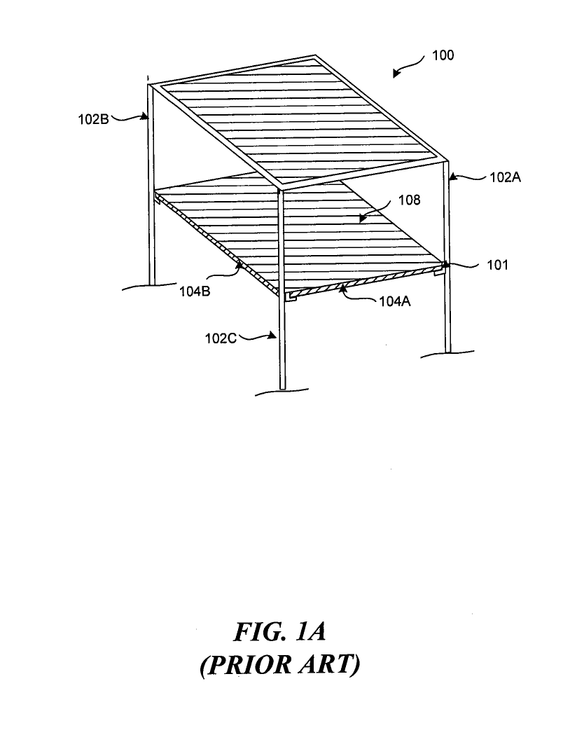

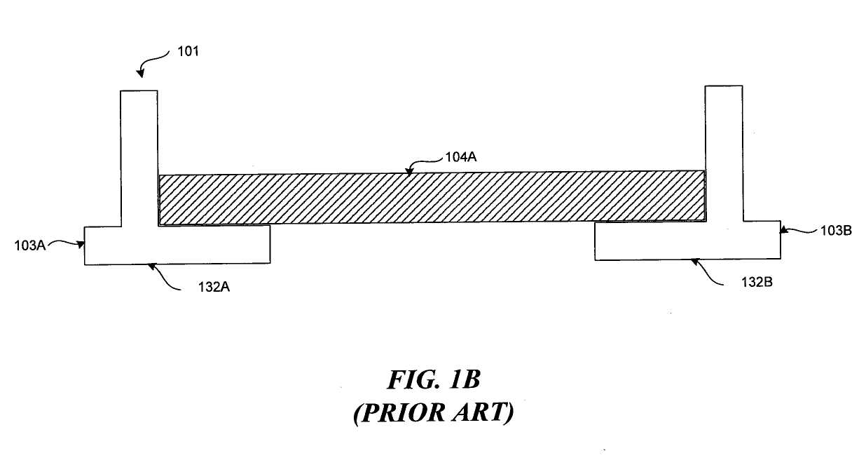

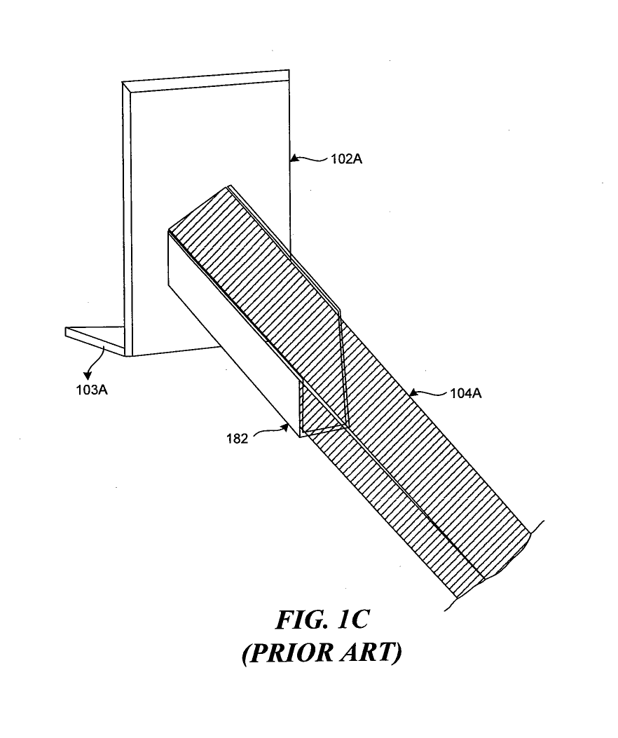

The stretcher 204A may also be constructed from any material as understood in the art, and is not restricted to any size, dimension, or orientation. The length of the stretcher 204A may be adapted and adjusted based on a final design requirement of the shelving assembly. In embodiments, the stretcher may be constructed as two inter-lockable sliding bars that are capable of sliding over each other (not shown in FIG. 2A). In such an arrangement, the length of the stretcher may easily be adjusted in situ based on design requirements. In embodiments, the stretcher 204A may be part of a shelf (not shown in FIG. 2A, but similar to the shelf 108 depicted with reference to FIG. 1A) that is eventually to be placed by interconnecting multiple beams. In such examples, the stretcher 204A may simply be a side of the shelf or may be permanently or temporarily affixed to the shelf.

In embodiments, and as will be discussed in more detail below, the stretcher 204A may include one or more slots 218. The slot, as defined herein, is a hollow feature at a given distance from an end of the stretcher. The slot 218 may take any form or shape, as long as it enables the stretcher to be slid on to a bracket, as will be described herein. In some instances, the slot may be open at one end (through which a protruding surface of a bracket may be slid in), but may be covered or otherwise unopened on another end of the stretcher. Accordingly, any shape, form, type of opening of the slot 218, as may be envisioned by a person of ordinary skill in the art, are all equally contemplated by the techniques described herein. This slot 218 allows the stretcher to be slid over the protruding surface of a bracket 212 attached to the beam 202A. As shown in the zoom-in sections 210 and 214, the stretcher 204A is brought directly over the brackets (in embodiments, one bracket per end of the stretcher 204A), and simply slide over the bracket such that the protruding surface of the bracket fits within the slot 218 of the stretcher 204A.

In this manner, the stretcher 204A is connected and interlocked between the two beams 202A and 202B. The bracket 212, by virtue of its lock feature, does not require a screw or other such permanent fixture mechanisms (e.g., bolting, welding, etc.) to be locked within the beam. Similarly, the stretcher 204A simply slides over the protruding surface feature of the bracket 212, eliminating the need for any permanent fixture mechanisms to secure the bracket 212 or the beam 204A. Despite the lack of permanent fixture mechanisms, the improved shelving assembly described herein possesses the structural integrity offered by permanent fixture mechanisms. For example, the stretcher and bracket assembly lock the stretcher 204A in position—because the slots of the stretcher are slid over the protruding surface, the stretcher 204A is locked in that position and cannot be moved or slid from the position. Accordingly, the beams 202A and 202B, by virtue of being held in place by the interconnected stretcher 204A, are also held in position. Any load on the beams that may cause the beams 202A and 202B to splay (i.e., bulge outwards or inwards) is transferred to the stretcher 204A. The stretcher 204A, by virtue of being locked in position by the bracket, dissipates the load laterally to the bottom of the beam structure. Furthermore, it can be envisioned that the structural integrity of the shelving assembly increases with the increase in number of stretchers used to interconnect the beams 202A and 202B. FIG. 2B illustrates a further embodiment of the improved shelving assembly, where an accessory 252 is attached to the stretcher 204B. As is evident from FIG. 2B, the interlocking effect provided by the bracket 212 secures the stretcher 204B in position and prevents the stretcher 204B from twisting due to the load of the accessory 252 or load that may eventually be added to the accessory 252.

In addition to providing the structural integrity advantages discussed above, the shelving assembly described herein also provides aesthetic advantages over the permanent fixture assemblies. Because, in embodiments, the protruding extension slides completely within the slot extension, the features of the bracket are hidden to a casual observer. There are no unsightly screw extensions or coverings that may impair the aesthetic appeal or value of the shelf. Another advantage of the shelving assembly discussed herein is the easy usability and flexibility. A user can simply slide the stretcher out of the brackets without the need for any tools, and further easily refit the stretcher at another location of the beam by simply inserting the brackets and sliding the stretcher over the protruding extensions of the brackets. There is simply no need for any tools or special labor in the attachment and removal of the stretchers.

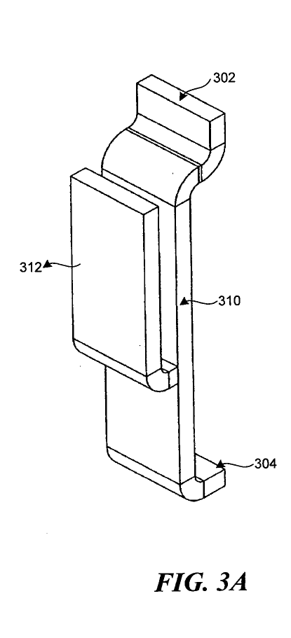

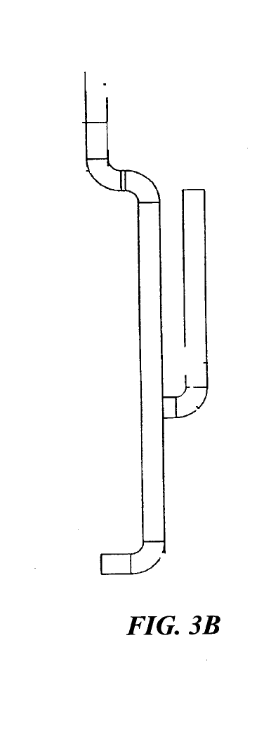

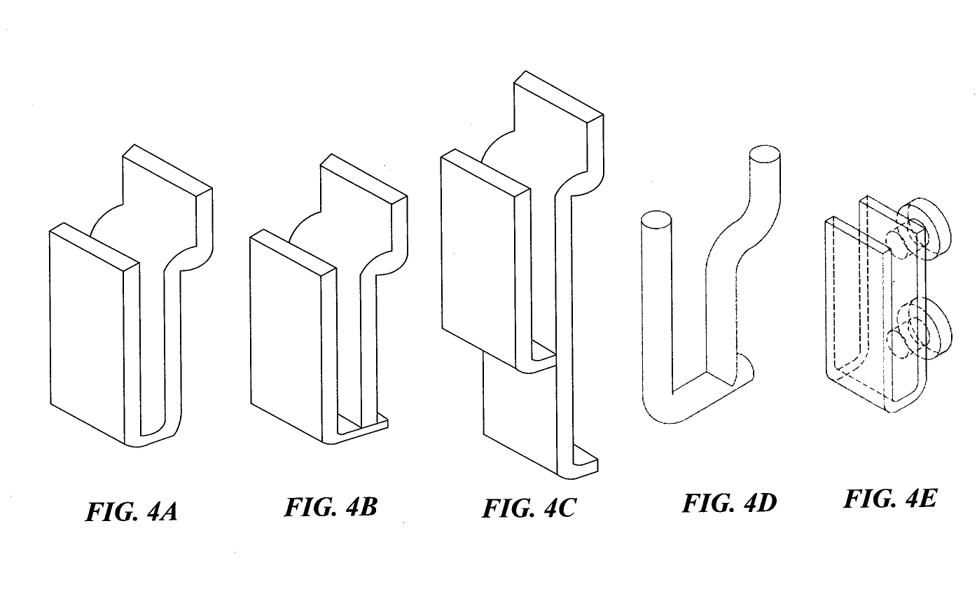

The above discussion of FIG. 2A provided an overall description of the improved shelving assembly. FIG. 3A now illustrates an exemplary embodiment of a bracket 212 used in the improved shelving assembly. It is understood that the embodiment in FIG. 3A is for the purpose of illustration only, and it is conceivable that the structure of the bracket may be altered in manners understood by one of ordinary skill in the art, while still providing the benefits of the improved assembly discussed herein. In the exemplary embodiment of FIG. 3A, the bracket comprises a base surface 310, a bracket extension with a protruding surface 312, and one or more hook members 302 and 304. In the way of an illustrative description, the bracket 212 has an upper portion and a lower portion relative to the base surface. The upper portion is where the bracket extension with the protruding surface 312 is located. In the illustrated embodiment, the protruding surface is connected to the base surface 310 in a U-type connection. That is, the protruding surface 312 and the base surface 310 are connected using a junction at one end such that the protruding surface 312 and the base surface 310 are substantially parallel to each other. Of course, in embodiments, the two surfaces may not necessarily be parallel, as long as the protruding surface 312 allows a slot 218 of the stretcher 204A to easily slide over the protruding surface 312 to form the interlocked assembly described above. The hook members 302 and 304 enable the bracket 212 to be secured to, for example, punches in the beam 202A. Again, it is not necessary to have a certain number of hook members. Other illustrative, but non-limiting examples of the bracket 212 are provided in FIGS. 4A-4E. As illustrated in the examples of FIGS. 4A-4E, the hook members(s) and the protruding surface may be arranged or realized in a variety of shapes, forms, manners, etc. in relation to the base surface of the bracket. FIG. 3B provides a side view of the exemplary embodiment of the bracket illustrated in FIG. 3A.

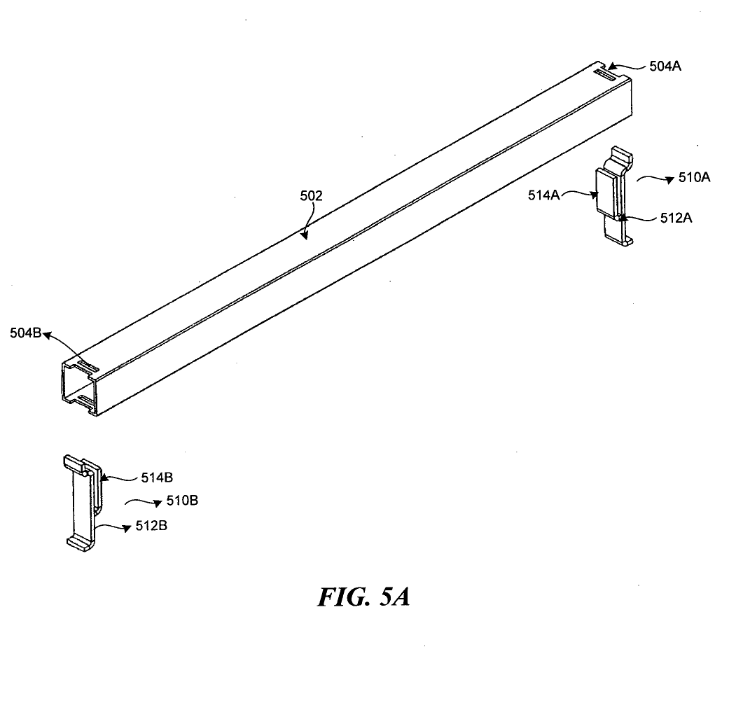

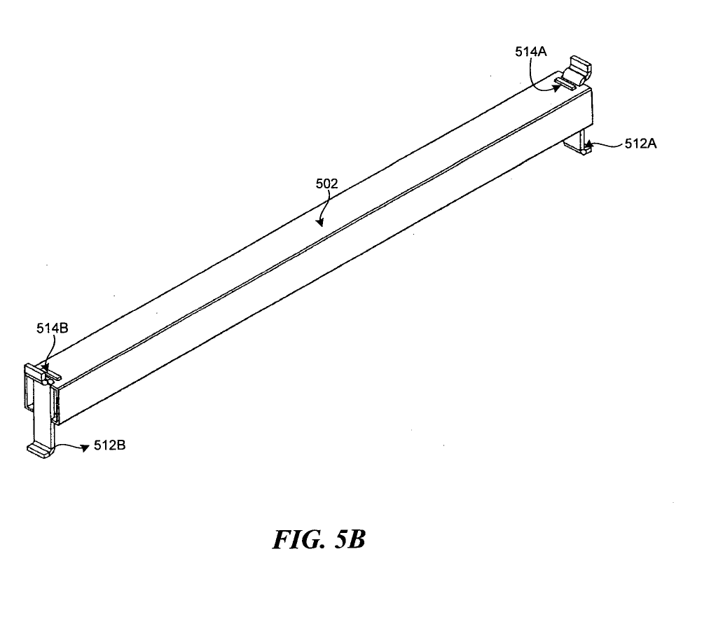

FIGS. 5A and 5B illustrate an exemplary process for sliding a stretcher 502 within two brackets 510A and 510B. As explained above, and as illustrated in FIGS. 5A and 5B, the stretcher 502 includes two slots 504A and 504B. In embodiments, the distance of slot 504A from a first end of the stretcher 502 is relative to or approximately equal to the distance between the base surface 512A and the protruding surface 514A of the bracket 510A. This distance allows for the slot 504B to easily slide over the protruding surface 514A when the stretcher 502 is to be secured to a corresponding beam. FIG. 5A illustrates a scenario where the stretcher 502 is aligned to be secured to two beams (not shown in FIG. 5A) by sliding the slots 504A and 504B of the stretcher over the protruding surfaces 514A and 514B of the brackets 510A and 510B. FIG. 5B illustrates a scenario where the stretcher 502 has been secured to the two beams by sliding the stretcher 502 within the brackets 510A and 510B (i.e., by sliding the slots 504A and 504B of the stretcher within the protruding surfaces 514A and 514B of the brackets 510A and 510B).

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

We claim:

1. A furniture assembly, comprising:
a plurality of beams;
a stretcher configured to be attached between a first beam and a second beam of the plurality of beams, the stretcher having a slot to enable attachment to one of the first or the second beam; and
a plurality of brackets, a given bracket of the plurality of brackets configured to secure a given end of the stretcher to the first beam, the given bracket having:
a hook member allowing the given bracket to be locked to the first beam; and
a bracket extension having a protruding surface, the protruding surface configured to slide within the slot of the stretcher, causing the given end of the stretcher to be secured to the first beam.

2. The furniture assembly of claim 1, wherein the first beam includes a plurality of channels, further wherein the hook member of the given end of the stretcher is configured to be locked within one of the plurality of channels of the first beam.

3. The furniture assembly of claim 1, wherein the given bracket further includes a base surface, and wherein the hook member is at a lower portion of the base surface and the protruding surface is at an upper portion of the base surface.

4. The furniture assembly of claim 3, wherein the protruding surface of the given bracket is substantially parallel to the base surface of the given bracket.

5. The furniture assembly of claim 3, wherein, upon being secured to the first beam, the base surface and the protruding surface of the given bracket are substantially parallel to the first beam.

6. The furniture assembly of claim 3, wherein a distance of the slot from the given end of the stretcher is commensurate to a distance of the protruding surface from the base surface of the given bracket.

7. The furniture assembly of claim 3, wherein the given bracket has a plurality of hook members, each of the plurality of hook members located at either end of the base surface of the given bracket.

8. The furniture assembly of claim 1, wherein the stretcher is adapted to be attached between the first beam and the second beam by means of a first bracket and a second bracket, the stretcher further including a first slot and a second slot, the first slot located adjacent to a first end of the stretcher, the second slot located adjacent to a second end of the stretcher, wherein subsequent to the first bracket and second bracket being secured to the first and second beams respectively, the first slot of the stretcher slides within a first protruding surface of the first bracket and the second slot slides within a second protruding surface of the second bracket, causing the stretcher to be attached between the first and the second beams.

9. The furniture assembly of claim 1, wherein the stretcher, by being secured to the first beam and the second beam by means of a plurality of brackets, prevents the first beam and the second beam from splaying due to addition of load.

10. A method for securing a stretcher to a plurality of beams in a furniture assembly, the stretcher having a first slot and a second slot to enable attachment to the plurality of beams, the method comprising:
fastening a first bracket and a second bracket respectively to a first beam and a second beam of the plurality of beams, each of the first and second brackets including:
a hook member allowing each bracket to be secured to a corresponding beam;
a bracket extension having a protruding surface, the protruding surface configured to hold the stretcher; and
securing the stretcher to the first and the second beams by sliding the first slot of the stretcher over the protruding surface of the first bracket and sliding the second slot of the stretcher over the protruding surface of the second bracket.

11. The method of claim 10, wherein the first beam and the second beam include a plurality of channels, further wherein said fastening a first bracket and a second bracket to a first beam and a second beam further comprises:
fastening the first bracket and the second bracket at a desired height of the plurality of beams based on a selection of a specific plurality of channels at the desired height.

12. The method of claim 10, wherein the given bracket further includes a base surface, and wherein the hook member is at a lower portion of the base surface and the protruding surface is at an upper portion of the base surface.

13. The method of claim 12, wherein the protruding surface of the given bracket is substantially parallel to the base surface of the given bracket.

14. The method of claim 12, wherein, upon being secured to the first beam, the base surface and the protruding surface of the given bracket are substantially parallel to the first beam.

15. The method of claim 12, wherein a distance of the slot from the given end of the stretcher is commensurate to a distance of the protruding surface from the base surface of the given bracket.

16. A bracket for enabling a given end of a stretcher to be secured to a given beam of a plurality of beams in a furniture assembly, the bracket comprising:
a base surface;
a hook member attached to a first portion of the base surface, the hook member allowing the bracket to be locked to the given beam; and
a bracket extension attached to a second portion of the base surface, the bracket extension having a protruding surface configured to slide within a slot in the stretcher, causing the given end of the stretcher to be secured to the first beam.

17. The bracket of claim 16, wherein the protruding surface of the bracket is substantially parallel to the base surface.

18. The bracket of claim 16, wherein, upon being secured to the given beam, the base surface and the protruding surface of the bracket are substantially parallel to the given beam.

19. The bracket of claim 16, wherein a distance of the slot from the given end of the stretcher is commensurate to a distance of the protruding surface from the base surface of the bracket.

20. The bracket of claim 16, wherein the given bracket has a plurality of hook members to lock for allowing the bracket to be locked to the given beam.
